(19) United States
(12) Patent Application Publication
(10) Pub. No.: US 2011/0191116 A1
(43) Pub. Date: Aug. 4, 2011

(54) METHOD FOR MONITORING THE MEDICAL CONDITION OF A PATIENT

(75) Inventor: Thomas Löser, Leipzig (DE)

(73) Assignee: Löser Medizintechnik GmbH, Leipzig (DE)

(21) Appl. No.: 13/055,410

(22) PCT Filed: Jul. 23, 2009
(86) PCT No.: PCT/DE2009/001027

§ 371 Date: Apr. 12, 2011

(30) Foreign Application Priority Data
Jul. 24, 2008 (DE) 10 2008 034 736.1
Dec. 2, 2008 (DE) 10 2008 059 901.8

(51) Int. Cl. G06Q 50/00

(52) U.S. Cl. 705/2

(57) ABSTRACT

The invention relates to a method for monitoring the medical condition of a patient. Provided is:
(a) continuously recording values of physiological parameters of the patient, wherein at least a part of the physiological parameters is characteristic of the presence of a disturbance of health;
(b) recording the taken medical measures for each of these patients, wherein for each taken medical measure at least the time-related beginning of the medical measure is recorded and the medical measure is assigned to at least one of the recorded physiological parameters that shall be affected with the medical measure;
(c) assigning the taken medical measure to a set category, wherein each category comprises a large number of potential medical measures;
(d) assigning the category to which the medical measure in step (c) has been assigned to one of the recorded physiological parameters being characteristic of the presence of a disturbance of health; and
(e) commonly and time-dependently representing the category and the assigned physiological parameter.

The invention relates to a method for monitoring the medical condition of a patient as well as a system for carrying out this method.

In the public health system, in particular in hospitals, there are employed patient data management systems wherein the patient data are stored. In addition to the so called master data of the patient such as name, Christian name, and date of birth the patient data comprise the medical findings and initiated or already finished medical or caring measures. In the following such measures are also referred to as medical measures.

As a rule, the medical findings are laboratory results, for example in cardiac diseases relevant measured values such as the myoglobin value, the troponine I value, and the CKMB value; in respiratory diseases relevant measured values such as the blood gas analysis e.g., the pH value of the blood, the partial oxygen pressure of the blood, the partial pressure of carbon dioxide of the blood, and the oxygen saturation of the blood.

The data stored in the patient data management systems are entered into the system via standardized interfaces (in hospitals HL7, in practices xDT) by the persons treating the patient as well as by the laboratory personnel and on request placed at the disposal of the treating person.

In particular, with multimorbid patients the number of data that have to be recorded for each individual patient by the patient data management system is extremely high. However, due to the considerable medical advance at present with supposedly simple diseases a large number of data are recorded that often do not allow a proper analysis. Thus, it is not atypical that medical decisions are made on the basis of single data that are considered to be particularly conspicuous. Other data stored in the patient data management system that could support an other findings are ignored, so that due to rather arbitrarily selected data medical measures are taken that in complete analysis of all data could turn out to be false or insufficient.

A further serious disadvantage of known patient data management systems is the complicated control of the efficacy of the medical measures taken, in particular of the medication. In particular, in known systems it can be determined hardly and as a rule only very late what effects a taken medical measure has on the development of a patient's physical condition. It is further not atypical that the discontinuation of a medical measure, for example a medicament, is overlooked, namely because it is not evident at first sight that such an order does exist, which connection exits between said order and the condition of the patient, or which purpose the order should originally have.

Moreover, it is a widespread problem that indeed not all of the patient's data that should be recorded indeed are recorded. Nevertheless, it is often not evident to the responsible physicians and nurses that there are data missing.

A further problem is that almost every hospital uses different forms for the documentation of the recorded data. Fitting the patient data management systems to these different forms (also referred to as monitoring sheet) is associated with high efforts. However, on the other side the responsible physicians and nurses of the respective hospital are used to the used form. Changes of such forms are associated with high bureaucratically efforts and yet a large number of mistakes.

Object of the invention is to eliminate the disadvantages according to the state of the art. In particular, a method for monitoring the medical condition of a patient should be indicated which enables a performance review of medical measures taken and thus a proper medical treatment that may be associated with a noticeable reduction of the period of treatment of a patient. Moreover, it shall be ensured that indeed all data of a patient that have to be recorded according to the guidelines made are actually recorded after all. Further, a system for carrying out said method shall be indicated.

This object is solved by the features of claims 1 and 17. Suitable developments of the inventions result from the features of claims 2 to 16.

In accordance to the invention there is provided a method for monitoring the medical condition of a patient comprising
(a) continuously recording values of physiological parameters of the patient, wherein at least a part of the physiological parameters is characteristic of the presence of a disturbance of health;
(b) recording the taken medical measures for each of these patients, wherein for each taken medical measure at least the time-related beginning of the medical measure is recorded and the medical measure is assigned to at least one of the recorded physiological parameters that shall be affected with the medical measure;
(c) assigning the taken medical measure to a set category, wherein each category comprises a large number of potential medical measures;
(d) assigning the category to which the medical measure in step (c) has been assigned to one of the recorded physiological parameters being characteristic of the presence of a disturbance of health; and
(e) commonly and time-dependently representing the category and the assigned physiological parameter.

By the common and time-dependent representation of the category and the assigned physiological parameter the physician can immediately recognize the connection between the condition of the patient, measured values of physiological parameters characteristic for said condition, and the taken medical measures.

Preferably, the taken medical measure is the administration of a drug, in particular the administration of a medicament.

It is preferred to set up the categories on the basis of given features that are inherent in a part of the potential medical measures only. Such features are for example the active ingredient of the drug, the group of the active ingredients of said drug, and/or the intended pharmacological effect of said drug.

For each medical measure that has to be taken for a certain patient the beginning of the medical measure is recorded. However, it is more suitable to record also further data about the medical measure in step (b). Such further data may be selected from the group comprising for example the intended end of the taken medical measure, the real end of the taken medical measure, the name of the prescribed drug, the pharmacological parameters such as the form of administration, the dose, the frequency of the dose per day, and the time-related division of the dosage during the day and the change of the dosage during an intended period of time as well as combinations of these data.

Advantageously, in step (b) in addition to the medical measure taken by the physician for a certain patient also the aim of said medical measure is recorded, the so-called target of the therapy. As a rule, the aim of a medical measure will be the change of one or more parameters continuously recorded in step (a) in a given period of time. Thus, the physician together with the medical measure is able to prescribe in which period of time a parameter set up by himself reaches a certain value (in the following referred to as target value) or a certain range (in the following referred to as target range). Whether the given parameters reach the target value or the target range is continuously examined during the continuous recording of the values of the given parameter or of the given parameters in step (a).

When the continuous examination shows that the target value or the target range has been reached before the end of the given period of time, then a message is given which informs the physician that the intended success of the medical measure has occurred and thus the medical measure can be canceled. So the physician is called on to bring the taken medical measure to an end.

When the continuous examination shows that the target value or the target range was not reached within the given period of time, then on expiry of that period an alert is emitted that informs the physician that the intended success of the medical measure has not occurred. So, the physician is informed that the measure must be examined. For that, the physician has to decide whether the medical measure shall be continued unchanged or whether another medical measure should be taken. When the physician is of the opinion that the medical measure already taken shall be continued, then in on embodiment of the invention he is requested by a signal to confirm the existing target value or the existing target range or to set a changed target value or a changed target range that should be reached in a period of time that was also set by himself.

When the continuous examination shows that the target value or the target range was reached at the time of the expiry of the given period of time, then a signal is given that informs the physician that the intended success of the medical measure has occurred and thus the medical measure can be canceled. So the physician is requested to bring the taken medical measure to an end.

This embodiment of the invention has the advantage that the taken medical measure is subjected to a performance review. In the present practice a taken medical measure is simply continued because the responsible physician is no longer aware that such a measure has been taken. This practice is not only associated with unnecessary cost but also with a health risk for the patient. The recommended method shall get the physician to formulate the therapy target and to control the achievement of said therapy target simultaneously with taking the medical measure.

The target value or the target range of the parameter(s) that the physician wants to affect with the taken medical measure can be set by the physician due to his expert knowledge. Alternatively or additionally, proposals can be made to him. Such proposals can be presented to the physician for example in the form of a list. The proposals are based on values taken from databases wherein target ranges and target values are deposited. Preferably, these target values and target ranges consider the age and/or the condition of the patient.

By a target value for example a body temperature of 36.7° C., by a target range a body temperature of less than or equal 36.7° C. (≦36.7° C.) or 36.7 to 37.5° C. may be understood. By a period of time for example a period of 24 hrs or seven days may be understood. For example, the therapy target of the delivery of an antifebrile agent such as paracetamol may be to reduce the values of the parameter body temperature to a target range of from 36.7 to 37.5° C. within 24 hrs.

Preferably, the medical measure in step (b) is assigned to a parameter for which a therapy target is given.

In a preferred embodiment the name of the prescribed drug is recorded wherein by means of the name of the prescribed drug the category of the taken medical measure is determined with recourse to a database wherein the name of the drug is linked with at least one feature of active ingredient, group of active ingredients, or intended pharmacological effect. For example, the indication of the name “Nebilet” or the name “Lobivon” can be linked with the active ingredient “Nebivolol”, the group of active ingredients “β1-adrenoreceptor blockers”, and the pharmacological effect “reduction of pulse rate and blood pressure”.

Since as a rule, it is not interesting for the success of a medical measure how the drug is called but only its active ingredient or group of active ingredients is of importance to such a success the creation of the category can be made for example in accordance with the feature “active ingredient”. That is, in step (e) in addition to the assigned physiological parameter for example the category “β1-adrenoreceptor blockers” would be indicated that has been created on the basis of the feature “group of active ingredients”. The physician immediately sees in step (e) that a β1-adrenoreceptor blocker has been prescribed; which β1-adrenoreceptor blocker this actually is in the concrete is unimportant in this context. Of course, the physician can call up details of the prescribed medical measures that have been recorded in step (b) if he considers it necessary.

Preferably, the assignment of a medical measure to a category in step (b) is carried out automatically, i.e. the physician himself must not make the assignment of the measure taken by himself. It is rather determined automatically by means of the taken measure to which category said measure is assigned.

In one embodiment of the invention the physiological parameter to which the category in step (d) is assigned is the same parameter as the physiological parameter to which the medical measure in step (b) has been assigned. Alternatively or additionally, the physiological parameter to which the category in step (d) is assigned is another physiological parameter than the physiological parameter to which the medical measure in step (b) has been assigned. The latter embodiment can be of advantage in particular in view of the broad-spectrum of a large number of drugs. For example, if a physician prescribes a β1-adrenoreceptor blocker to achieve a lowering of the blood pressure this may have effects on the patient's hepatic function. In this case, it may be advisable to link the category “β1-adrenoreceptor blocker” not only with the measured values of the blood pressure but also with physiological parameters that are connected with the patient's hepatic function, for example with measured values of the glutamic-pyruvic transaminase (GPT).

It is preferred that in step (e) the category and the assigned physiological parameter(s) are represented in a diagram the abscissa of which forms the time wherein in the diagram there are represented measured values of the assigned physiological parameter and the category of the taken measure. Suitably, in this case the category is shown in the diagram as a bar running parallel to the abscissa wherein in particular the beginning of the measure is represented as the start of the bar in the diagram. At the end of the measure the presentation of the category, for example of the bar, in the diagram ends. In a further embodiment of the invention the category of the taken measure is represented as color-coded bar wherein color-coding is linked with the given feature.

The term “physiological parameter” means a value indicating (a) the measured value of a measured physiological characteristic of a patient or an indicator (e.g. the oxygen partial pressure in a blood analysis, respiratory rate, body temperature, CKMB concentration); and (b) can comprise a classification of a physiological condition of a patient (e.g. yellow coloration of the facial skin).

The term “indicator” herein relates to compounds or elements that—depending on their type—are produced in biological systems or are introduced in biological systems and the presence or concentration of which (e.g., in a certain organ) is a characteristic for a biological process or a biological condition. For example, such compounds and elements comprise those produced by tumor cells, induced by a tumor in other body cells, and/or changed by a tumor as tumor-specific substances in their concentration. Such indicators are for example macromolecules, e.g. proteins, or trace elements. Such compounds and elements further comprise bone markers that are characteristic of osteoclasis processes such as osteoporosis.

The term “value” or “measured value” herein relates (a) to all numerical values for a physiological parameter that result in the medical field (e.g. an oxygen partial pressure in a blood gas analysis of 81.2 mmHg, a respiratory rate of 15 breathes per minute, a body temperature of 36.8° C., CKMB concentration of 152 ng/ml), or (b) to classification results of a physiological condition of a patient (e.g. yellow coloration of the facial skin: no, wherein to classifications by means of statements such as “No” a numerical value, for example “0” should be assigned).

Preferably, at least the values of one of the physiological parameters that are characteristic of the presence of a disturbance of health are determined using an indicator.

Here, physiological parameters should be selected that due to medical findings are believed to be connected with a certain disturbance of health, for example a respiratory insufficiency. For determining the medical risk of a respiratory insufficiency there are employed for example physiological parameters that are obtained by means of a blood gas analysis. The physiological parameters obtained by means of the blood gas analysis can comprise the pH value of the blood, the blood's oxygen partial pressure, the blood's partial pressure of carbon dioxide, and the oxygen saturation of blood. Further physiological parameters that can be used to assess the medical risk of a respiratory insufficiency in the method according to the invention comprise in addition to the values resulting from the blood gas analysis the respiratory rate (AF) of the patient as well as the age and sex of the patient.

The number of the various physiological parameters the values of which are recorded in step (a) should be at least 2.

The term “continuous recording” of the physiological parameters means the recording of said parameters as soon as they are arisen.

The term “medical measure” comprises every medical or caring measure that is taken to improve the physical condition of the patient, for example to lead one or more of the recorded physiological parameters into a range that is typical of healthy persons.

The taken medical measures can also be recorded continuously, i.e. every further measure, every change of an existing measure (e.g. of the dosage of a medicament) and/or the real end of a measure are recorded.

In a further embodiment of the method according to the invention an additional step may be provided wherein the completeness of the data is examined. The examination of the completeness of the data may be continuous. Alternatively, it is carried out at expiry of a given period of time, for example every four, eight, sixteen, and/or twenty four hours. Said time intervals may correspond to the duration of a shift or a working day of the hospital.

The data are considered complete if they comply with the medical guidelines, in particular with the taken medical measures as well as the physiological parameters and other information that have to be recorded in accordance to the guidelines of the hospital in general and the guidelines of the physician in particular.

The data that have to be recorded in accordance to the medical guidelines are in the following also referred to as “expected data”, since their recording in accordance to the medical guidelines is expected. Single expected data are referred to as “expected indication”.

In order to examine the completeness of the data the actually recorded data are compared with data that have to be recorded in accordance to the medical guidelines. In that occasion, the recorded data are assigned to the expected data. For example, when the recording of the oxygen partial pressure is expected, then the value actually measured and recorded for the oxygen partial pressure is assigned to the expected value. Each expected indication can be linked with one or more specified times from which it is evident when a value is expected for the expected indication.

The comparison of the recorded data with the expected data either shows that (i) all expected data also correspond with recorded data, i.e., that all expected data have also been recorded; that (ii) only a part of the expected data corresponds also with recorded data, i.e., that only a part of the expected data have been recorded, while another part of the expected data has not been recorded; or that (iii) none of the expected data correspond with recorded data, i.e. that none of the expected data have been recorded. In the cases (ii) and (iii) preferably a warning is emitted after a given time interval. For that, the fields in the screen presentation can be provided for example with a color-coding. Preferably, the color of the border and/or inscription of the field is changed if one of the cases (ii) or (iii) arises. In a preferred embodiment a warning is only emitted at the given time intervals, namely every four, eight, sixteen, and/or twenty four hours, in order to avoid a permanent warning each for another expected indication. In other words, when an examination of the completeness of the recorded data is set after four hours, then beforehand no warnings are emitted, even if the guideline has not been met at an earlier point of time, for example already one hour before the expiry of the time interval of four hours.

When the monitoring sheet that is used by the respective hospital is deposited in the system for monitoring the medical condition of a large number of patients then the warning happens by color-coding of the respective areas of the monitoring sheet shown on the screen wherein expected indications for which no data have been recorded are present. In this case, no warnings are emitted for the individual fields in which an expected indication remained without recorded data. In these areas expected indications are summarized in accordance to given criteria. Such areas are for example “perfusion”, “infusion”, and “decubitus” each comprising several expected data.

It may be provided that by selection of such an area a documentation sheet can be called up on the screen wherein then the expected indication is characterized for example by color-coding for which no data have been recorded.

Further, in accordance to the invention a system for monitoring the medical condition of a large number of patients according to the method of the present invention is provided. The system comprises a processor, a memory, an input device, and a display device, wherein
the input device enables the user to indicate the taken medical measures for each patient;
in the memory the continuously recorded values of physiological parameters of the large number of patients and the taken medical measures for each of these patients are stored;
the processor assigns the taken medical measure to a given category and assigns the category to one of the recorded physiological parameters being characteristic of the presence of a disturbance of health; and
the display device commonly and time-dependently represents the category and the assigned physiological parameter.

Furthermore, in the memory there can be deposited databases for the categories and given features to form the categories.

It is further possible that the system comprises a device for the examination of the completeness of the data.

The system may be a computer-implemented system.

In the following, the invention is explained in more detail with respect to drawings. Here

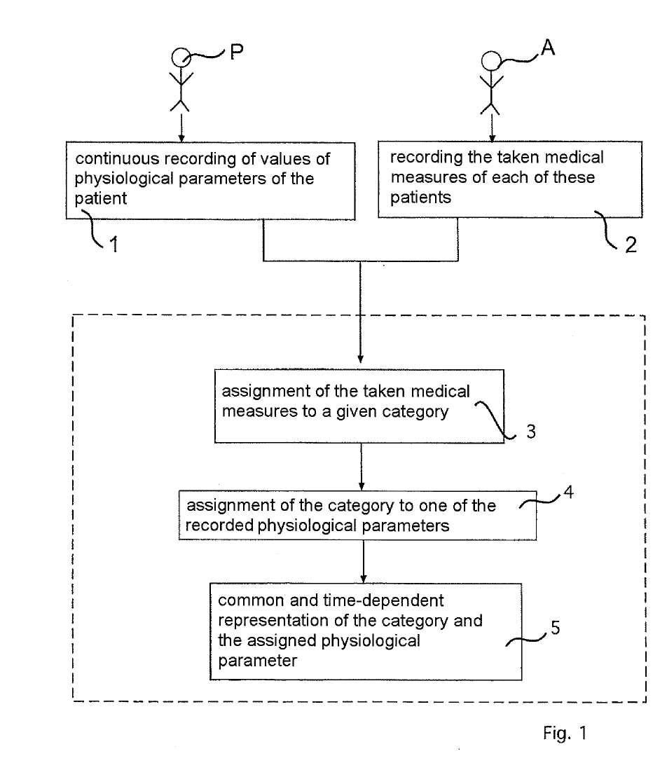

FIG. 1 shows a schematic representation of a first embodiment of the method according to the invention;

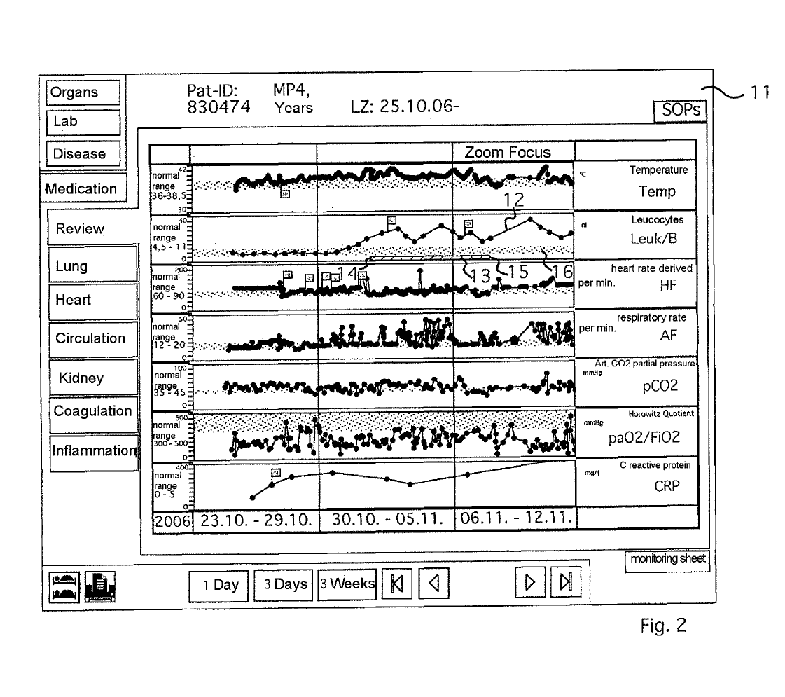

FIG. 2 shows a schematic representation of a screen image of the display device according to the invention, and

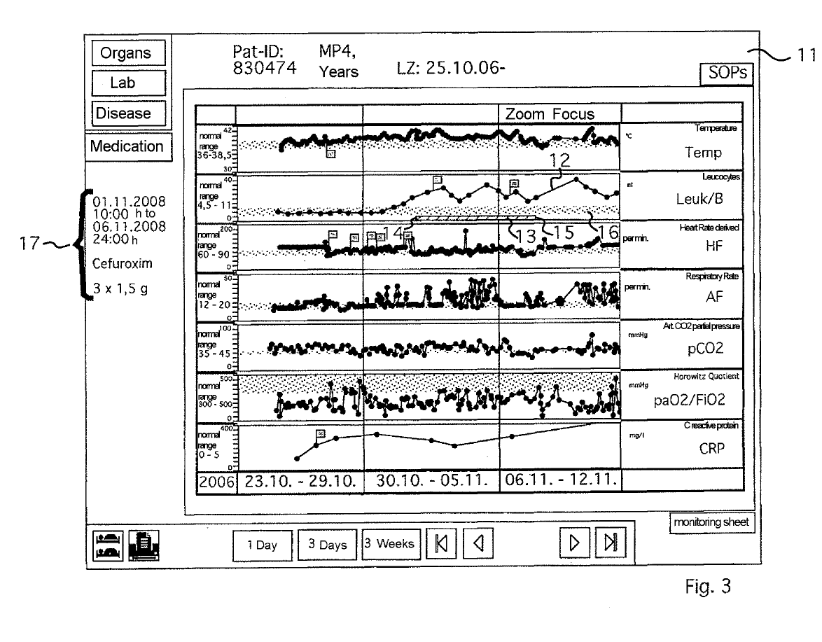

FIG. 3 shows a further schematic representation of a screen image of the display device according to the invention;

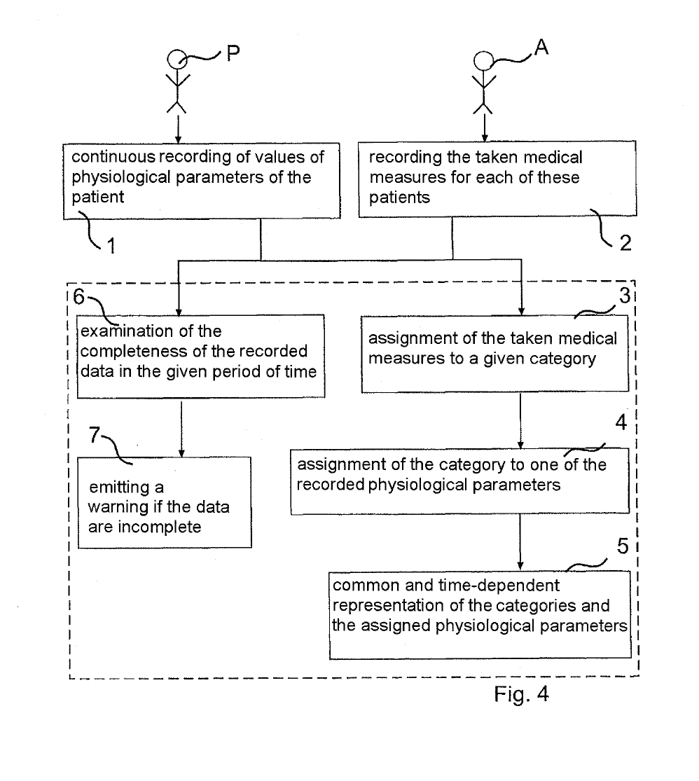

FIG. 4 shows a schematic representation of a second embodiment of the method according to the invention;

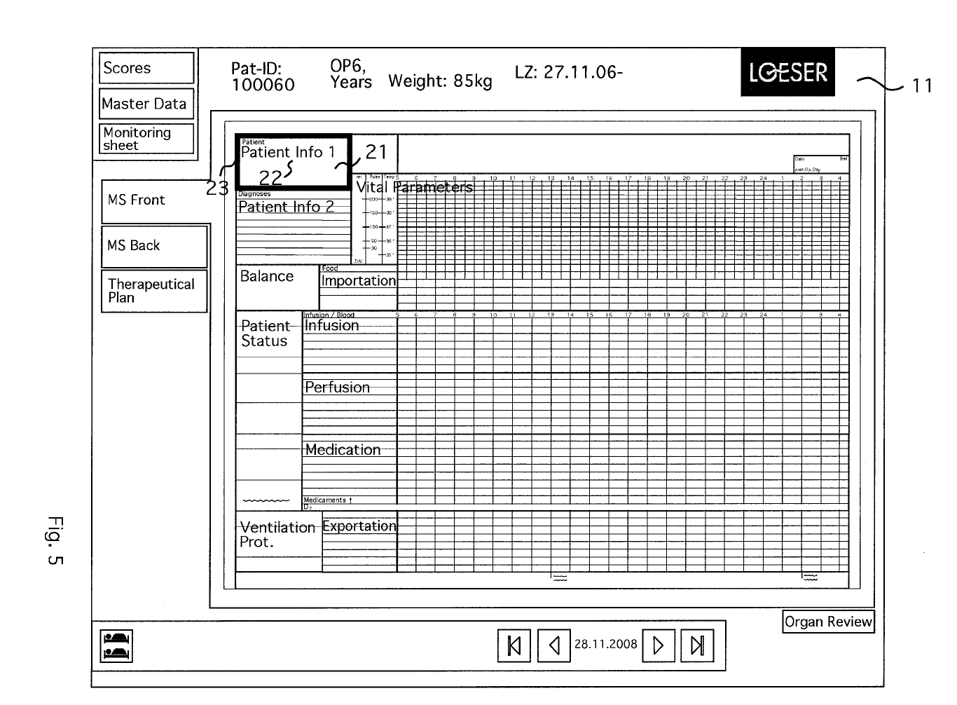

FIG. 5 shows a schematic representation of a screen image of the display device according to the invention;

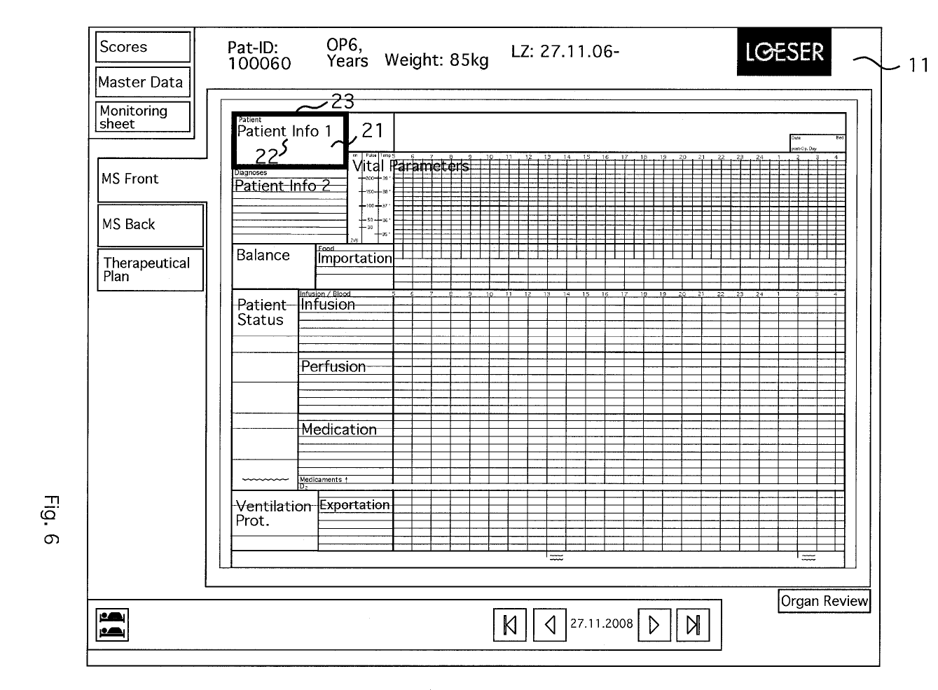

FIG. 6 shows a further schematic representation of a screen image of the display device according to the invention, and

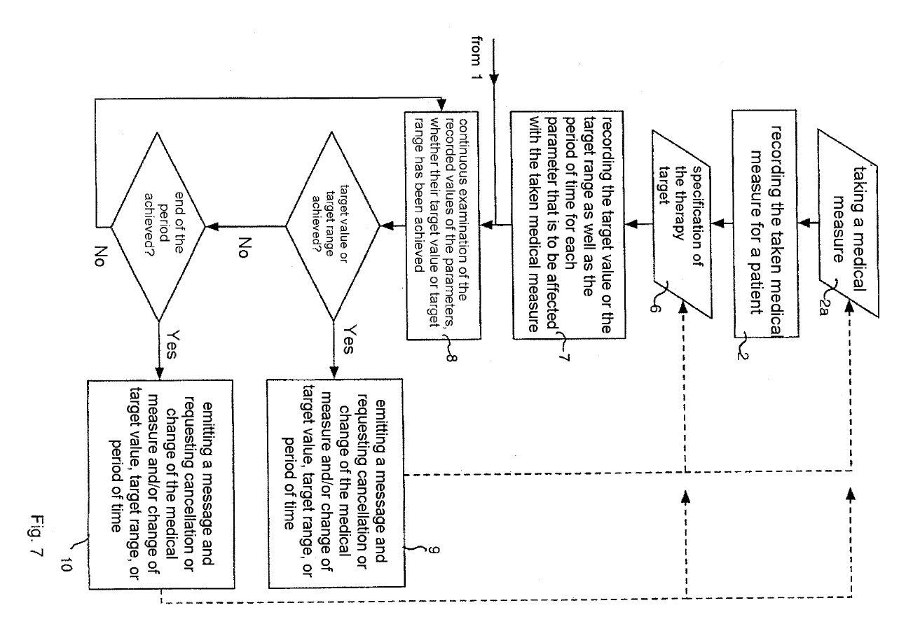

FIG. 7 shows a schematic representation of a third embodiment of the method according to the invention.

According to FIG. 1 in a first embodiment of the invention a number of physiological parameters of a patient P is recorded 1. A physician A, for example a doctor, now takes a medical measure in view of the condition of the patient P reflecting in the recorded physiological parameters. This may be the prescription of a medicament.

The medical measure that has been taken by the physician for a certain patient is recorded by the system according to the invention, for example by means of an input device 2. In that occasion, the beginning of the taken medical measure, the intended end of the taken medical measure, the name of the prescribed medicament, the form of administration, the dose, the frequency of the dose per day, and the time-related distribution of the dosage during the day, and the change of the dosage during a given period of time are recorded. Moreover, the physician will assign the medical measure to at least one of the recorded physiological parameters that is to be affected with the medical measure.

Changes of the measures occurring later in time as well as their real end are also recorded over time.

Then, the taken medical measure is assigned to a given category 3. Then, the category is assigned to one of the recorded physiological parameters, as a rule, to the physiological parameter that is to be affected with the taken medical measure.

Finally, the category and the assigned physiological parameter are represented commonly and time-dependently on the display device of the system according to the invention 5.

Screen images 11 of the display device are shown in FIGS. 2 and 3. There, a part of the recorded physiological parameters is shown, namely body temperature (Temp [° C.]) of the patient, its white blood cell count (Leuk/B [nl]), heart rate (HF [min⁻¹]), respiratory rate (AF [min⁻¹]), arterial partial pressure of carbon dioxide (pCO2 [mmHg], Horowitz quotient (paCO2/FiO2 [mmHg]) and concentration of the C-reactive protein (CRP [mg/l]).

The physiological parameter 12, i.e. white blood cell count, is represented graphically as a function of time forming the abscissa. The physiological parameter 12 is the assigned parameter (step d) in accordance to the present invention. Said physiological parameter is linked with a taken medical measure, as is shown by the bar 13. The bar 13 reveals with respect to the abscissa the start 14 and the end 15 of the taken medical measure. The medical measure is assigned to a particular category, as is evident from the hachures of the bar 13 standing for a particular color-coding. In addition, a further bar 16 is shown characterizing the desired range of the physiological parameter 12.

By the common and time-dependent representation of category and assigned parameter a physician is readily able to see that a medical measure was taken. On the basis of the coded representation of the category he can further see, what kind of medical measure has been taken. He is thus able to link the measured values of the assigned parameter immediately with the taken medical measure involving a considerable advantage in view of the therapeutic success and thus the duration of treatment.

When the physician wishes more information regarding the taken medical measure, then he can choose to view them by selection of the bar by means of the input device, as is shown in FIG. 3, reference mark 17. He can then recognize that the active ingredient “Cefuroxim” has been prescribed, namely from Nov. 1, 2008 (beginning of the medical measure) until Nov. 6, 2008 (end of the medical measure), with a dose of 1.5 g three times a day.

In that occasion, the active ingredient “Cefuroxim” that is for example commercially sold under the name “Zinacef” has been assigned to the category “β-lactam antibiotics”. The aim of the medical measure was to control a bacterial inflammation. It is evident to physician from the diagram for the white blood cell count as assigned physiological parameter 12 that the prescription of the active ingredient “Cefuroxim” had the following effect: The inflammation was successfully controlled for a time reflecting in the drop of the measured value.

Of course there can be shown further taken medical measures and physiological parameters assigned thereto simultaneously with the medical measure shown in FIG. 2 and FIG. 3 and the physiological parameter assigned thereto.

In FIG. 4 there is shown a second embodiment of the method according to the invention corresponding to the first embodiment (see FIG. 1) except that additionally an examination of the recorded data for completeness is carried out 6. When at that the recorded data are proved to be incomplete a warning is emitted 7. In FIGS. 5 and 6 a screen image 11 is shown representing a monitoring sheet. The fields of the monitoring sheet are divided in areas 21 wherein several expected indications are summarized. The areas are provided with an inscription 22 and a color-coding. If the examination shows after the given period of time that the recorded data are incomplete then the color of the inscription 22 of the area 21 and the color of the border 23 of the area 21 are changing. In FIG. 5 the screen image 11 is shown prior to the examination 6, whereas in FIG. 6 the screen image 11 is shown after the examination 6. In FIG. 5 each of the areas 21 has a black inscription 22 and a black border 23. It can be seen in FIG. 6 that warnings have been emitted 7 that are represented by the white border 23 of the respective areas 21. Alternatively or additionally, also a white inscription 22 of the respective areas 21 would be possible.

Here, the screen image 11 corresponds—apart from the inscription and color-coding of the areas 21—to the monitoring sheet that is typically used by the hospital.

According to FIG. 7 it may be provided to supplement or in addition to the embodiments shown in FIGS. 1 and 4 that the physician not only takes a medical measure 2a that is recorded by the system (2) but also specifies the target that is linked with this measure (6). This target is the therapy target and comprises the specification of the target values or ranges of the parameter(s) that are continuously recorded (1) and have to be affected with the medical measure (2) as well as the period of time within which the target value or target range has to be achieved. The therapy target is recorded by the system (7).

The continuously recorded values of parameters (1) for which a therapy target has been formulated are examined continuously whether the therapy target has been achieved (8). When the target value or target range has been achieved within the given period of time then a signal is generated that informs the physician that the therapy target has been achieved. The physician is requested to cancel the medical measure, to change the medical measure, or to formulate a new therapy target. When the given period of time has expired without the therapy target being achieved then a signal is generated that informs the physician about this fact (10). The physician is requested to cancel the medical measure, to change the medical measure, or to formulate a new therapy target.

### LIST OF REFERENCE MARKS

P Patient
A Physician
1 Continuous recording of physiological parameters
2 Recording of medical measures
3 Assignment of the medical measures to a category
4 Assignment of the category to a recorded physiological parameter
5 Representation of category and assigned parameter
6 Specification of therapy target
7 Recording the therapy target
8 Continuous examination of the recorded values with the therapy target
9 Signal emitting, if the therapy is achieved
10 Signal emitting, if the period of time is expired
11 Screen image of a display device
12 Assigned physiological parameter
13 Taken medical measure
14 Beginning of the medical measure
15 End of the medical measure
16 Desired range of the assigned physiological parameter
17 Indications of details of the taken medical measure
21 Area
22 Inscription of the area
23 Border of the area

1-17. (canceled)

18. A method for monitoring the medical condition of a patient, comprising:
(a) continuously recording values of at least two different physiological parameters of the patient, wherein at least a part of the physiological parameters is characteristic of the presence of a disturbance of health;
(b) recording the taken medical measures for each of these patients, wherein for each taken medical measure at least the time-related beginning and the intended end of the medical measure are recorded and the medical measure is assigned by the physician to at least one of the recorded physiological parameters that shall be affected with the medical measure;
(c) automatically assigning the taken medical measure to a set category, wherein each category comprises a large number of potential medical measures;
(d) assigning the category to which the medical measure in step (c) has been assigned to one of the recorded physiological parameters being characteristic of the presence of a disturbance of health by the physician, wherein the physiological parameter is another physiological parameter than the physiological parameter to which the medical measure in step (b) has been assigned; and
(e) commonly and time-dependently representing the category and the assigned physiological parameter.

19. A method according to claim 18, wherein the taken medical measure is the administration of a drug.

20. A method according to claim 18, wherein the categories are formed on the basis of given features that are inherent in a part of the potential medical measures only.

21. A method according to claim 20, wherein the features on the basis of which the categories are formed comprise the active ingredient of a drug.

22. A method according to claim 20, wherein the features on the basis of which the categories are formed comprise the group of active ingredients of a drug.

23. A method according to claim 20, wherein the features on the basis of which the categories are formed comprise the intended pharmacological effect of a drug.

24. A method according to claim 19, wherein in step (b), in addition to the beginning of the medical measure, the name of the prescribed drug is recorded.

25. A method according to claim 24, wherein on the basis of the name of the prescribed drug the category of the taken medical measure is determined with recourse to a database wherein the name of the drug is linked with at least one feature of active ingredient, group of active ingredients, or intended pharmacological effect.

26. A method according to claim 18, wherein in step (e) the category and the assigned physiological parameter are represented in a diagram the abscissa of which forms the time wherein in the diagram measured values of the assigned physiological parameter and the category of the taken measure are represented.

27. A method according to claim 18, wherein the category of the taken measure is represented as color-coded bar wherein the color-coding is linked with the given feature.
